(19) United States
(12) Patent Application Publication
(10) Pub. No.: US 2014/0235278 A1
(43) Pub. Date: Aug. 21, 2014

(54) SYSTEMS AND METHODS FOR POSITION BASED SERVICES IN A MOBILE DEVICE

(71) Applicant: Kyocera Corporation, Kyoto (JP)

(72) Inventors: Diego KAPLAN, San Diego, CA (US); Bilhan KIRBAS, San Diego, CA (US); Jonathan K. Kies, Encinitas, CA (US)

(73) Assignee: Kyocera Corporation, Kyoto (JP)

(21) Appl. No.: 14/263,676

(22) Filed: Apr. 28, 2014

Related U.S. Application Data
(62) Division of application No. 11/237,203, filed on Sep. 27, 2005.

(51) Int. Cl. H04W 4/02; H04M 1/725

(52) U.S. Cl. CPC H04W 4/02; H04M 1/72572
USPC 455/456.3; 455/566

(57) ABSTRACT

A method of constructing a position sensitive screensaver on a mobile device comprises acquiring a position for the mobile device, reporting the position, receiving information for selected information categories based on the reported position, and displaying the received information on the mobile device, when the mobile device is idle. The subscriber can preferably control where and how the information is displayed so that the user has relevant information based on where the subscriber is located.

### RELATED APPLICATIONS

This application is a divisional application of U.S. patent application entitled “SYSTEMS AND METHODS FOR POSITION BASED SERVICES IN A MOBILE DEVICE”, Ser. No. 11/237,203, filed on Sep. 27, 2005 and incorporated by reference to its entirety, herein.

### BACKGROUND OF THE INVENTION

1. Field of the Invention

The invention relates generally to wireless communication, and particularly to systems and methods for providing enhanced position based services to a mobile device operating within a wireless communication system.

2. Background

Positioning capabilities are common in today's wireless communication systems. Positioning capability enables, for example, enhanced 911 (E911) service, which allows the position of a distressed caller to be immediately and automatically pinpointed for emergency service personnel. But E911 services are not revenue generators for wireless system operators. Therefore, such operators are understandably looking for ways to generate revenue from the positioning capability to subsidize services such as E911 and to increase profits. To generate revenue, such services need to add value to the subscriber so that the subscriber is willing to pay for such services. Therefore, system operators need value added services that take advantage of the positioning capability.

Positioning capability is typically provided via the Global Positioning System (GPS). A traditional GPS receiver receives and processes specially coded satellite communication signals. The satellite signals are generated from an array of satellites that comprise the GPS system. Nominally, this array consists of 24 satellites arranged in various orbits such that between 5 and 8 satellites are visible from any point on earth. GPS receivers convert the satellite signals into position, velocity, and time estimates. Four satellites are required to compute the three position dimensions (x, y, z) as well as the time.

FIG. 1 illustrates an exemplary communication system 100 with GPS positioning capability. System 100 comprises a wireless mobile device 106 in communication over communication channel 108 with a base station 110. Base station 110 is, for example, at the center of a communication cell within a Wireless-Wide Area Network (W-WAN). Thus, mobile device 106 includes the requisite antenna and transceiver for communicating over communication channel 108. Additionally, mobile device 106 also includes an antenna and associated GPS circuitry for receiving the satellite signals over satellite communication channels 104 from GPS satellites 102. In this implementation, the GPS circuitry decodes the satellite signals. The satellite signals are then sent to a Position Determination Entity (PDE) (112) interfaced with base station 110. PDE 112 determines the position of mobile device 106 from the decoded satellite signals and this information is transmitted back to mobile device 106, where it can, for example, be displayed on mobile device 106.

Thus, for example, if the subscriber wants to know his position, he can input a position request into mobile device 106. Mobile device 106 then acquires satellite signal information over satellite communication channels 104 using the GPS circuitry. The GPS circuitry decodes the satellite signals and mobile device 106 transmits the decoded signals to PDE 112 over communication channel 108. PDE 112 generates the position information from the decoded signals and transmits a position back to mobile device 106 where it can be displayed to the subscriber on mobile device 106. PDE 112 can also be used to provide mobile device 106 with Access Assist (AA) and Sensitivity Assist (SA) information, which helps mobile device 106 acquire satellites 102 over satellite communication channels 104.

Alternatively, device 106 can incorporate all the resources required to receive and decode satellite signals 104 and to determine its position from the decoded signals. In either case, the problem is the same: How does the system operator generate revenue from the positioning capability of system 100? Stated another way, what type of value added services can be developed to take advantage of the positioning capability of system 100?

### SUMMARY OF THE INVENTION

The systems and methods described herein are directed to value added services that take advantage of GPS positioning ability within conventional wireless communication systems. In one aspect, a position sensitive screensaver displays subscriber selected information on the mobile device screen when the mobile device is idle. The subscriber can, therefore, receive relevant information, such as traffic or weather reports, on the subscriber's mobile device. Preferably, the information provided is dependent on the position of the mobile device. For example, the weather or traffic information will not simply be generic information, but will be based on the weather or traffic for the area around the mobile device's current position.

In another aspect of the invention, a mobile device is configured to allow a subscriber to associate personalized names with locations that are defined by the position of the mobile device. For example, the subscriber can define a work, home, or city location, each of which is defined in relation to a certain position of the mobile device. The user can then, for example, be alerted to their location using a personalized name, as opposed to a position that is simply defined in terms of latitude and longitude.

Importantly, such aspects provide added value to the user, which the system operator can leverage into revenue.

Other aspects, advantages, and novel features of the invention will become apparent from the following Detailed Description of Preferred Embodiments, when considered in conjunction with the accompanying drawings.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a diagram illustrating an exemplary wireless communication system that includes positioning capability;

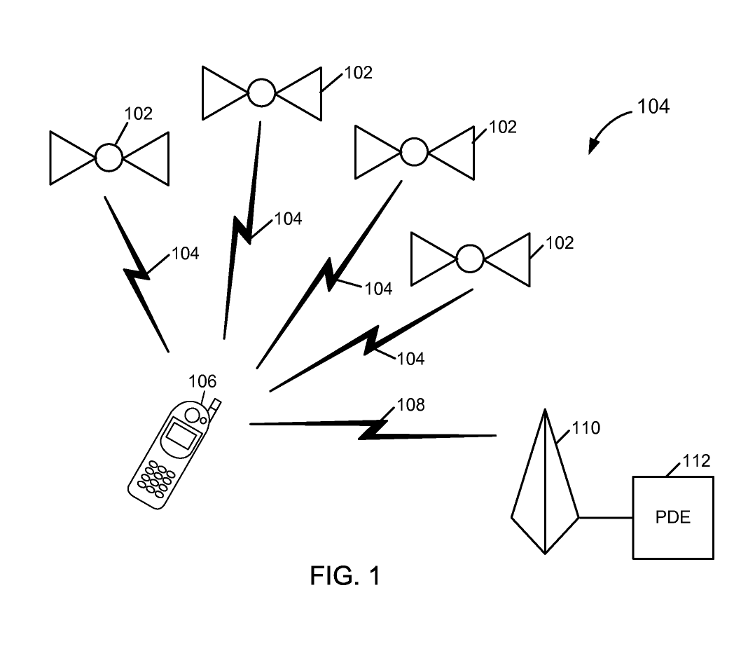

FIG. 2 is a diagram illustrating an example embodiment of a mobile device configured to operate in the system of FIG. 1 and to display a position sensitive screen saver in accordance with the invention;

FIG. 3 is a logical block diagram illustrating exemplary components that can be included in the device of FIG. 2;

FIG. 4 is a flow chart illustrating one example process for displaying a position sensitive screen saver in accordance with the invention;

FIG. 5 is a flow chart illustrating one example process for GPS location definition in accordance with the invention;

FIG. 6 is a diagram illustrating locations defined using the process of FIG. 5; and

FIG. 7 is a flow chart illustrating one example process for sharing location information in accordance with the invention.

### DETAILED DESCRIPTION OF THE PREFERRED EMBODIMENTS

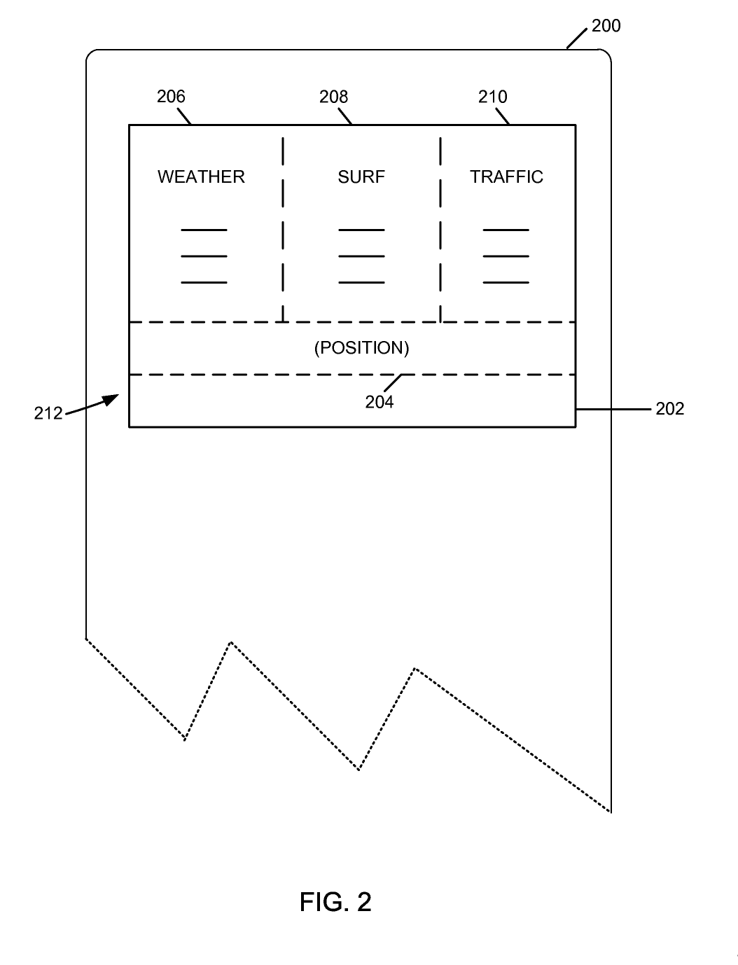

FIG. 2, illustrates an exemplary mobile device 200 that displays a position sensitive screen saver 212 on display 202 in accordance with the systems and methods described herein. Preferably, position sensitive screen saver 212 provides the subscriber with position specific data. For example, screen saver 212 can display the current position of device 200 or alternatively, screen saver 212 can display the location of device 200.

The difference between location and position is discussed more fully below. Briefly, however, the term “position” is used in this specification and the claims that follow to refer to the position of the device in terms of latitude and longitude, as is typically provided by a GPS receiver. In certain embodiments, the altitude, speed, and direction are also provided by a GPS receiver, and can be displayed by position sensitive screen saver 212. For the purposes of this specification and the claims that follow, “location” is a translation of the position to an area. For example, the present position of a mobile device may reveal that the device is “located” in the city of San Diego. Thus, the position of the mobile device is the latitude and longitude coordinates of the device and the location is San Diego.

Other types of information that can be displayed by screen saver 212 are fog alerts, temperature, sunrise/sunset, moonrise/moonset, tide information, surf reports, etc. Further, the type of information displayed can preferably change depending on the position or location of the user. For example, if the user is in an inland position, the inland weather can be displayed on display 202. If the user moves towards the coast, then not only can the weather be updated to provide weather information for the coastal region, but a local surf report can also be displayed on display 202.

Like conventional screen savers, position sensitive screen saver 212 can be displayed when device 200 is idle. As a result, screen saver 212 does not interfere with the regular functioning of device 200, yet it provides the subscriber with a value-added service, e.g., a weather or traffic report. Moreover, a position sensitive screen saver 212 is easy to implement and has a low implementation cost, but will generate revenue for the system operator due to airtime usage when the screen saver updates its information.

In one embodiment, the system operator or device manufacturer determines the information displayed by position sensitive screen saver 212. Preferably, however, the subscriber can select what type of information he receives. Different methods for allowing the subscriber to select information categories from which he will receive information are discussed below. But in addition, the subscriber can also preferably control where on display 202 different information is displayed. To facilitate this capability, position sensitive screen saver 212 preferably comprise a plurality of information modules each configured to display specific types of information. Thus, for example, there may be a position (or location) module 204 that displays the current position of device 200. There can also be a weather module 206, a surf report module 208, and a traffic module 210, to name just a few.

Preferably, therefore, the subscriber can select which information modules are displayed by selecting specific information categories and then control where on display 202 they are displayed. In essence, the subscriber can construct a customized position sensitive screen saver 212. And because the information displayed can change based on position, the subscriber can preferably construct different position sensitive screen savers 212 for different positions or locations. This adds further value to the subscriber, because he can ensure that he obtains the information he wants depending on where he is.

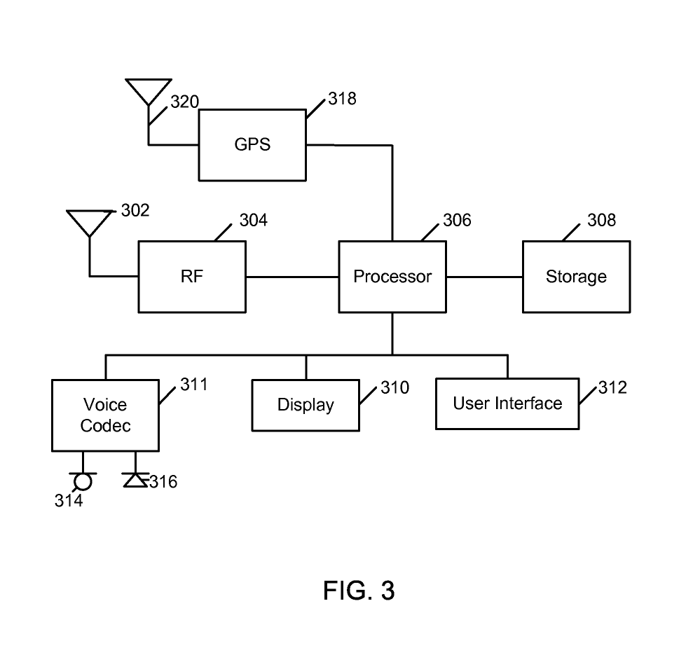

FIG. 3 illustrates a functional block diagram of exemplary components that can comprise a mobile device 300 configured to display a position sensitive screen saver 212. First, device 300 comprises an antenna 302 for transmitting and receiving RF signals that are modulated and demodulated by RF circuit 304. Device 300 also includes antenna 320 and GPS receiver 318 for receiving GPS signals. Additionally, device 300 includes a processor 306, which is configured to encode and decode the signals that are modulated and demodulated, respectively, by RF circuit 304. Processor 306 is also configured to control the operation of device 300 by running executable instructions stored as software code in storage device 308.

Device 300 also includes voice codec 311, for receiving audible signals via microphone 314 and encoding them into digital signals that can be encoded modulated and transmitted via antenna 302. Voice codec 311 is also configured to receive decoded signals from processor 306 and convert them to audible signals that can be output to a user via speaker 316.

Device 300 also includes a display 310 and a user interface 312. User interface 312 can, for example, comprise input buttons and switches, including a dial pad for entering numbers to be called using device 300. In general, the systems and methods described herein are compatible with any type of user input apparatus, including, e.g., touch screen technology, cursors, shuttle dials, etc.

Processor 306 preferably comprises multiple processing circuits. For example, processor 306 can comprise a microprocessor or microcontroller for executing the instructions stored in storage device 308 and controlling the operation of device 300. But processor 306 can further comprise, for example, a Digital Signal Processing (DSP) circuit for encoding and decoding the signals communicated between processor 306 and RF circuit 304. Moreover, voice codec 311 or other audio processing circuitry can also be included within processor 306. The circuits that comprise processor 306 can be packaged as one device, or some or all of the circuits can be included in device 300 as a standalone device as is illustrated in FIG. 3 with respect to voice codec 311.

Storage device 308 comprises memory circuits configured to store the software code as well as data used by processor 308 to control device 300. Storage device 308 can, for example, comprise multiple circuits such as a Flash memory for storing the software code, an Electrically Erasable Programmable Read Only Memory (EEPROM) for storing critical parameters and variables, and Static Random Access Memory (SRAM) for storing temporary instructions and data.

Thus, the software code used to implement a position sensitive screen saver 212, as well as the information category selections and display preferences, can be stored in storage device 308. Processor 306 can then be configured to access storage device 308 in order to run the software instructions and display the selected information in display 310 in accordance with the preferences when required by the position sensitive screen saver software instructions.

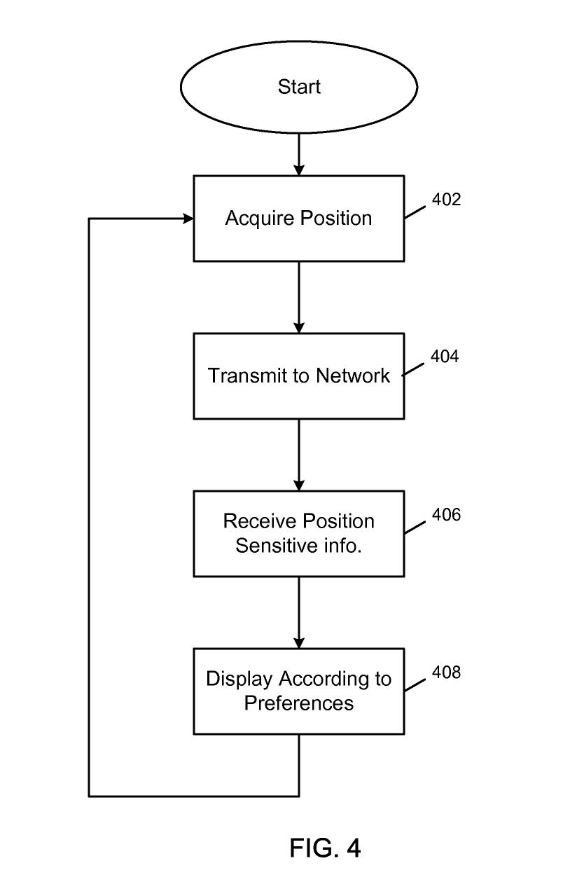

FIG. 4 is a flow chart that illustrates an example process for displaying a position sensitive screen saver 212 using a mobile device 300. First, in step 402, device 300 acquires its position using GPS receiver 318. Then, in step 404, device 300 reports the position to the communication system in which it is operating. These two steps can be accomplished in various ways, depending on how the position capability is implemented in the system. For example, if device 300 includes full positioning capability, then acquiring and reporting the device's position involves device 300 acquiring position information from GPS satellites, decoding the information, and determining the position (step 402). The determined position is then reported (step 404) by device 300 to the communication system. If on the other hand, device 300 uses a PDE to determine the position, then acquiring and reporting the position involves device 300 acquiring the satellite information and forwarding it to a PDE, which then determines the position of device 300. The determined position can then be forward (step 404) to the communication system by the PDE or by device 300 once it receives the position from the PDE.

In step 406, device 300 then receives information for the information categories selected by the subscriber. In step 408, the device's position sensitive screen saver 212 displays the information on display 310, in accordance with the display preferences of the subscriber.

There are several methods by which the display preferences can be implemented and stored. In one embodiment, the subscriber inputs the preferences using user interface 312 and the preferences are then stored in storage device 308. In this case, device 300 can transmit the information category selections to the communication system along with the present position in step 404, and then receive information only for the selected categories in step 406. Alternatively, the communication system can be configured to transmit information for all categories based on the position reported in step 402, which device 300 would receive in step 406. But device 300 can be configured to only display information for the selected categories in step 408.

An alternative method to storing the preferences on device 300 is to store them on the network portion of the communication system. Thus, after the subscriber has input his preferences, device 300 can transmit the preferences to the communication system to be stored in the network portion. When device 300 reports its position in step 404, the system can then respond by only transmitting information for the selected categories.

Other methods, besides user interface 312, can also be used to input the preferences. For example, the preferences can be entered in to a computing device, such as a desktop or laptop computer, and then downloaded into device 300 to be stored in storage device 308 or forwarded to the network to be stored. A computer can also be used to access a web site, constructed by the communication system operator, the device manufacturer, or some other ‘third party, where the subscriber can then enter his preferences. Preferably, the web site is hosted by a network server that is interfaced with the communication system. Thus, the preferences can be downloaded through the communication system to device 300 to be stored in storage device 308 or they can simply be downloaded and stored on the network portion of the communication system. The preferences can even be stored on the network server hosting the web site and accessed by the communication system when required.

It should be noted that the display preferences can include more than just what categories of information to display. First, it should be remembered that different information can be displayed based on the position of device 300. Therefore, the subscriber can preferably designate different information categories for different positions or locations. In addition, the subscriber can preferably control where and how the information is displayed on display 310. In essence, the subscriber can preferably construct different position sensitive screen savers 212, with unique information and display organization, for different positions. This further adds value to the subscriber, because not only does the subscriber receive the information he desires depending on where he is, but the information is also displayed to the subscriber in the order or arrangement that is most useful to the subscriber. Accordingly, the subscriber can preferably designate where on display 310 each piece of information, or each information module, is displayed.

In one embodiment, the subscriber can also change the format of the displayed information. For example, the subscriber can preferably control the appearance of each information module. This can include controlling how the information is presented within each module, the size of the module, and can also include, for example, the ability to change or associate icons or graphics with each module. Therefore, a weather information module can be configured to include a customized graphic, such as a sun or some other image associated with the weather, so that the subscriber can quickly locate the weather information module when desired.

Preferably, position and format information are stored on device 308. Otherwise, the information must be included with information received in step 406 from the communication system, which can increase system traffic to the detriment of other subscribers. But if the information is stored in storage device 308, then processor 306 can easily access it and display the information received in step 406 according to the subscriber's preferences.

As mentioned above, position sensitive screen saver 212 can display the position of device 200; however, it is more meaningful to the user if his position is displayed in terms of commonly used names for commonly visited places. Therefore, another value added service that can leverage the positioning capability of conventional wireless communication systems is to enable device 200 for GPS location definition. In general terms, GPS location definition according to the systems and methods described herein allows the subscriber to specify an area or location and associate a personalized name with the location. When device 200 determines that it is within the defined location, it can then be configured to display the personalized name. For example, instead of information module 204 displaying the position in terms of latitude and longitude, it can display the location in terms of commonly used names of places commonly visited by the subscriber. Thus, GPS location definition can be used in conjunction with a position sensitive screen saver, but it does not require a position sensitive screen saver and can be implemented without one.

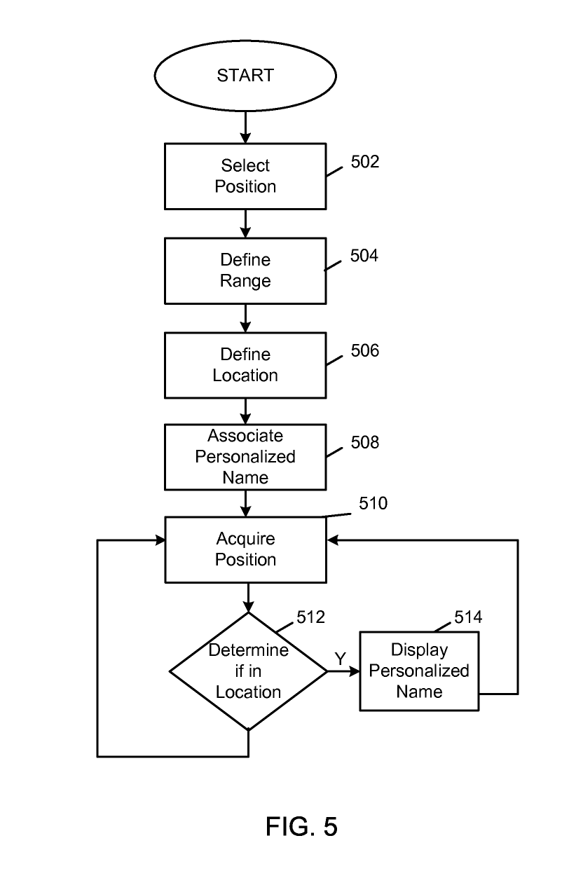

The flow chart of FIG. 5 illustrates an example process of GPS location definition in accordance with the systems and methods described herein. First, in step 502, the subscriber must select a position in relation to which the location will be defined. Therefore, the subscriber must supply longitude and latitude coordinates, which of course can be supplied by the positioning capability of the wireless communication system. Next, the subscriber must define a range, in step 504, to be associated with the location. The selected position and associated range are then used to define a location step 506. For example, the subscriber can easily define a circular location, in step 506, by specifying a position, in step 502, which will be treated as the center of the location. Then, in step 504, the user can supply a radius to define the circular boundary of the location.

The subscriber can carry out steps 502, 504 and 506 via user interface 312. For example, the subscriber can acquire a position using GPS receiver 318, specify that the position be used as the reference point for defining a location, and then enter range information to be associated with the reference point in such a manner as to define the boundaries of a location. In this case, it is easiest if the shape of the location is limited to regular shapes, such as circles, squares, rectangles, etc. This way, the information that the user must enter is kept to a minimum. For example, as explained, if the location is circular, the subscriber just needs to specify the center and input a radius. For a square, the subscriber could select a position, which can be used as a corner point and then enter a length, which is used as the length of each side of the square.

Alternatively, the user can use a computer running specialized software to create locations (step 506) with regular or irregular shapes. The greater computing power and memory space of a computer would allow much more flexibility in defining locations. The location information can then be downloaded in to device 300 and stored in storage device 308.

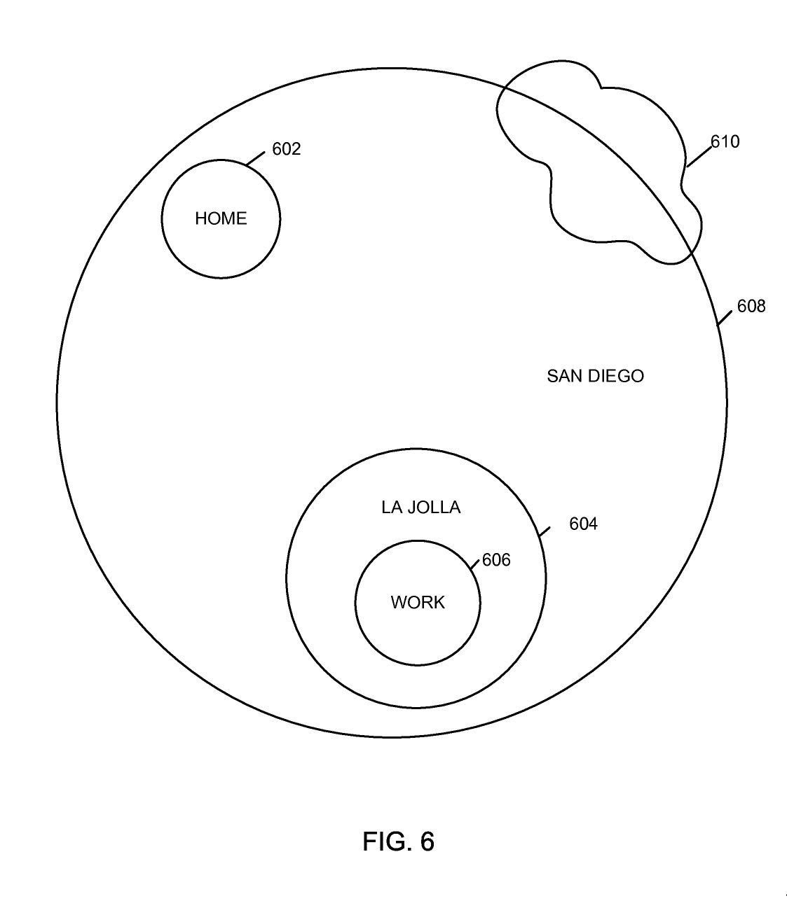

After a location is defined in step 506, the subscriber can associate a personalized name with the location in step 508. FIG. 6 illustrates a plurality of personalized locations 604, 606, and 608 that cover the area from a subscriber's home to his work. As can be seen, several locations of varying sizes have been defined and given the names Home (602), Work (606), La Jolla (604), and San Diego (608). In this example, each of the locations is a circular location and, therefore, could have easily been defined using the subscriber's mobile device. In addition an irregular shaped location 610 has also been defined, which could have been defined for example using a computer.

Next, as the subscriber moves from location to location, his mobile device will periodically acquire its position (step 510). This may be done by the device itself or in conjunction with a PDE. Then, in step 512, the device will determine if it is within one of the defined locations and display the personalized name of the location in step 514.

As can be seen in FIG. 6, the device may be in more than one location at a given time. For example, when the device is within Work location 606, it is also within La Jolla location 604, and San Diego location 608. Therefore, some mechanism for resolving which location names to display is required. In one embodiment, the smaller location is always displayed, e.g., work location 606 in the above example is displayed instead of La Jolla or San Diego, but some other approach can clearly be implemented as well.

Thus, GPS, location definition adds value to the subscriber, because it allows his location to be displayed in terms of a commonly used place name, which is more relevant than simple latitude and longitude information. Further, GPS location definition can be used in conjunction with a position sensitive screen saver to display information to the subscriber based on his location as opposed to his position.

Location definition can also be used to add value to the subscriber by enabling the subscriber to monitor the location of a mobile device from a remote location. For example, parents could monitor the location of their children by configuring the children's mobile devices to report their locations to the parent's mobile device. Alternatively, a subscriber may elect to share their position with another subscriber or mobile device user.

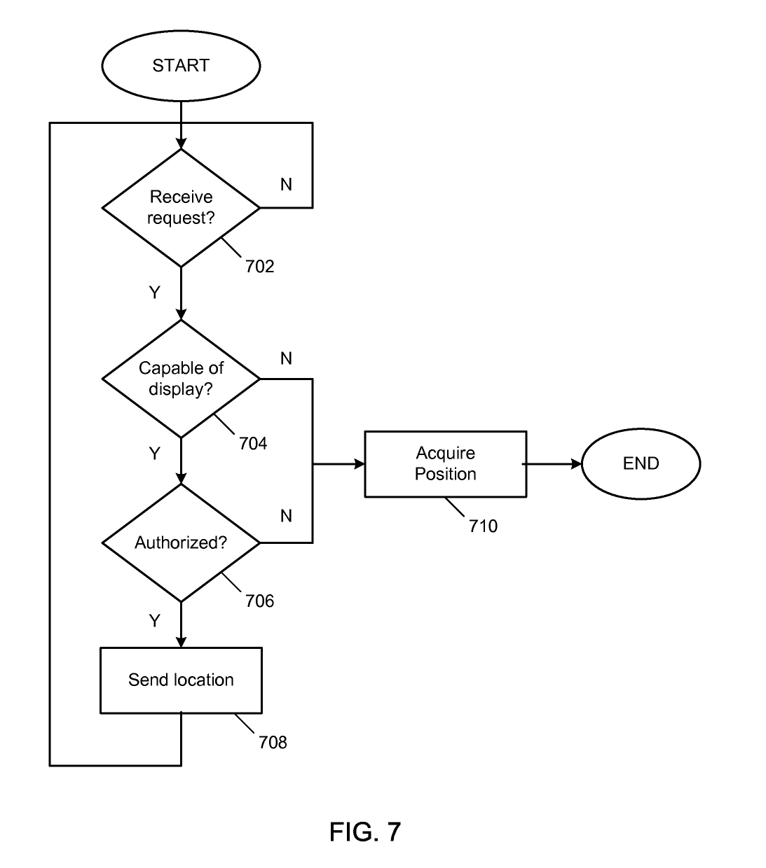

Such sharing of location information of course requires some security measures to ensure the privacy of the subscriber. Thus, the flow chart of FIG. 7 illustrates an example process by which security can be implemented with respect to a request for location received by a mobile device. In step 702, the request is received, for example, from another mobile device. In step 704, the subscriber's device queries the other mobile device to determine if it is capable of displaying the location. Then in step 706, the mobile device determines if the other mobile device is authorized to receive the location information. This can be set up ahead of time, for example, in a family service plan that authorizes each family member's device to acquire the location of each of the other family member's devices. If the other device is capable of displaying location information and is authorized to receive it, then in step 708 the device will forward the location information. In one embodiment, in step 710, the location information is not sent if the mobile device is determined to be incapable of displaying the location information or unauthorized to receive the location information.

Importantly, value added services such as those described above allow the system operator to generate revenue by charging the subscriber more for the communication device, the communication service supplied by the operator, or both. The subscriber is benefited, however, by the added value he receives and, therefore, is preferably willing to pay extra to receive the services. Alternatively, the system operator may not charge for the services, but use them instead to differentiate his service from other operators.

Accordingly, GPS location definition and a position sensitive screen saver are two value added services that can leverage the positioning capability of conventional mobile devices in order to generate revenue for system operators. Various methods for implementing a position sensitive screen saver and for GPS location definition have been shown and described; however, it will be clear that other implementations are possible. Therefore, while embodiments and implementations of the invention have been shown and described, it should be apparent that many more embodiments and implementations are within the scope of the invention. Accordingly, the invention is not to be restricted, except in light of the claims and their equivalents.

What is claimed is:

1. A method for a position sensitive screensaver on a mobile wireless communication device, the method comprising:
acquiring a position for the mobile wireless communication device;
reporting the position to a network;
receiving information for selected information categories based on the reported position, a selection of the selected information categories based on a user designation for the position;
receiving, through a user interface of the mobile wireless communication device, user input designating a size and a shape of an area associated with the position;
displaying the received information through the position sensitive screensaver on the mobile wireless communication device in accordance with a user defined display location and format; and
configuring the mobile wireless communication device to report the position to a second mobile wireless communication device.

2. The method of claim 1, wherein displaying the received information comprises displaying the received information when the mobile device is idle.

3. The method of claim 1, further comprising receiving display preferences and displaying the received information in accordance with the display preferences.

4. The method of claim 3, further comprising storing the display preferences in the mobile device.

5. The method of claim 3, further comprising storing the display preferences on a network.

6. The method of claim 3, wherein displaying the received information further comprises displaying information modules associated with each selected category on the mobile device.

7. The method of claim 6, wherein the display preferences comprise the selected information categories.

8. The method of claim 7, wherein the display preferences further comprise display locations and format for each of the selected information categories.

9. The method of claim 8, further comprising receiving and storing user entered location names corresponding to the mobile device positions.

10. The method of claim 1, wherein receiving information comprises:
receiving first information for a first set of selected information categories based on a first reported position, selection of the first set of selected information categories based on a user designation for the first reported position; and
receiving second information for a second, different set of selected information categories based on a second reported position, selection of the second set of selected information categories based on a user designation for the second reported position.

11. A mobile device comprising:
a positioning device configured to acquire a position of the mobile device;
a transceiver configured to report the position to a network and receive information from the network for selected information categories based on the reported position, the selected information categories designated by a user for the position, the transceiver further configured to report the position to a second mobile device;
a user interface configured to receive display preferences comprising a display location and format for each of the selected information categories, the user interface further configured to receive user input designating a size and a shape of an area associated with the position; and
a display configured to display a position sensitive screensaver in accordance with the format corresponding to the information category of the displayed information.

12. The mobile device of claim 11, further comprising a storage device configured to store the display preferences.

13. The mobile device of claim 11, wherein the position sensitive screen saver comprises information modules associated with each selected category.

14. The mobile device of claim 11, wherein the display preferences comprise the selected information categories.

15. The mobile device of claim 11, wherein the user interface is further configured to receive and store user entered location names corresponding to the mobile device positions.

16. A communication system, comprising:
a base station; and
a mobile device, configured to communicate with the base station, the mobile device comprising:
a positioning device configured to acquiring a position for the mobile device,
a transceiver configured to report the position to the base station-and receive information from the base station for selected information categories based on the reported position, the transceiver further configured to report the position to a second mobile device,
a user interface configured to receive display preferences comprising the selected information categories designated for a plurality of mobile device positions and a display location and format for each of the selected information categories, the user interface further configured to receive user input designating a size and a shape of an area associated with the position, and
a display configured to display a position sensitive screen saver comprising a user defined named location corresponding to the position and the received information at the display location and in accordance with the format corresponding to the information category of the displayed information and defined by the display preferences.

18. The communication system of claim 16, wherein the mobile device further comprises a storage device configured to store the display preferences.

19. The communication system of claim 16, wherein the position sensitive screen saver comprises information modules associated with each selected category.

20. The communication system of claim 16, wherein the display preferences comprise the selected information categories.

21. The communication system of claim 16, further comprising registers configured to store the display preferences.

22. The communication system of claim 21, wherein the mobile device is further configured to receive and store user entered location names corresponding to the mobile device positions.
